(19) United States
(12) Patent Application Publication
(10) Pub. No.: US 2017/0104249 A1
(43) Pub. Date: Apr. 13, 2017

(54) TRANSITION APPARATUS FOR AN ENERGY STORAGE APPARATUS, AND METHOD FOR PRODUCING AN ENERGY STORAGE APPARATUS

(71) Applicant: MAHLE International GmbH, Stuttgart (DE)

(72) Inventors: Oliver HEEG, Schwieberdingen (DE); Stefan HIRSCH, Stuttgart (DE); Caroline JANZEN, Stuttgart (DE); Achim WIEBELT, Neustadt (DE)

(73) Assignee: MAHLE International GmbH, Stuttgart (DE)

(21) Appl. No.: 15/386,310

(22) Filed: Dec. 21, 2016

Related U.S. Application Data
(63) Continuation of application No. PCT/EP2015/063029, filed on Jun. 11, 2015.

(30) Foreign Application Priority Data
Jun. 24, 2014 (DE) 10 2014 212 105.1

(51) Int. Cl. H01M 10/617; H01M 10/34; H01G 11/18; H01M 10/6572; H01M 10/6571; H01G 11/10; H01M 10/0525; H01M 10/625

(52) U.S. Cl. CPC H01M 10/617; H01M 10/0525; H01M 10/345; H01M 10/625; H01M 10/6572; H01M 10/6571; H01G 11/10; H01G 11/18; H01M 2220/20

(57) ABSTRACT

A transition apparatus for an energy storage device which has at least one energy store and one temperature-control device, in particular for a motor vehicle, wherein the transition apparatus is arranged between the energy store and the temperature-control device. The transition apparatus is distinguished in that a first incompressible layer is provided, wherein the first incompressible layer serves as a tolerance compensation layer.

This nonprovisional application is a continuation of International Application No. PCT/EP2015/063029, which was filed on Jun. 11, 2015, and which claims priority to German Patent Application No. 10 2014 212 105.1, which was filed in Germany on Jun. 24, 2014, and which are both herein incorporated by reference.

### BACKGROUND OF THE INVENTION

Field of the Invention

The invention relates to a transition apparatus for an energy storage device, in particular for a motor vehicle. Furthermore, the invention relates to a method for producing a transition apparatus and an energy storage device.

Description of the Background Art

Energy storage devices with an energy store, which has cells arranged in a stack, are used in modern hybrid electrical vehicles (HEV) or electric vehicles (EV) for storing electrical energy. Li-ion batteries or NiMH batteries or supercaps, for example, are used as high-performance energy stores. In the energy storage device, due to resistances within and outside the cells, rapid charging and discharging can lead to an increase in the temperature in individual cells and thereby to heating of the entire energy storage device. In this case, uneven heating of the individual cells can also be brought about. The temperature in the cells should not exceed 50° C., however, because temperatures above 50° C. could damage the cells of the energy store permanently. For this reason, it is necessary to cool the cells of the energy storage device, in particularly to cool them actively. At low external temperatures, in contrast, it is necessary to heat the energy storage device so as to achieve a minimal operating temperature of the cells in the energy store. For a long lifetime and maximum performance of the energy store, a temperature-control device is typically used in modern energy storage devices to realize both the cooling and heating of the cells. In this case, it is necessary to assure in particular that the cells of the energy storage device are substantially at the same temperature in each operating state and there is as homogeneous a distribution as possible of the temperature across all cells of the energy storage device. For the temperature control of the cells, the temperature-control device typically has a temperature-control plate, which is in thermal contact with the cells.

An energy storage device with a plurality of battery cells is known from EP 2 362 463 B1, which corresponds to US 2011/0206948. The battery cells are arranged in a battery stack and are in thermal contact with a cooling plate. A thermal insulation layer is arranged as a transition apparatus between the battery cells and the cooling plate in order to realize a uniform temperature distribution within a battery cell stack.

### SUMMARY OF THE INVENTION

It is therefore an object of the present invention to provide an improved transition apparatus and an improved energy storage device and a method for producing an energy storage device.

An exemplary embodiment relates to a transition apparatus for an energy storage device, which has at least one energy store and at least one temperature-control device and brings about a thermal transition between the temperature-control device and the energy store, in particular for a motor vehicle, whereby the transition apparatus is arranged between the energy store and the temperature-control device, whereby the transition apparatus has at least one first incompressible layer, which serves as a tolerance compensation layer. The tolerance compensation layer brings about an optimization of the heat transfer between the technically rough surfaces of the temperature-control device and of the energy store, in particular a temperature-control plate as a temperature-control device and an end plate or a bottom of the energy store.

The first incompressible layer can fill interspaces produced by the roughness profile, level the unevenness in contact surfaces of the temperature-control plate and/or the end plate, and thereby serve as a tolerance transition layer. Overall, therefore, an enlarged real thermal contact surface can be realized. The heat transfer resistance between the energy store and the temperature-control device can be reduced as a result. This can lead to improved heat transfer between the temperature-control device and the energy store. The first incompressible layer can thereby assure an optimized thermal contact. The first incompressible layer can preferably realize a reliable and unvarying contact by means of the incompressible property. The first incompressible layer is preferably free of bubbles and has no compressible bubbles, as is known for conventional tolerance compensation layers. The first incompressible layer can simultaneously realize a gluing of the components, the temperature-control device or temperature-control plate and energy store or end plate or bottom of the energy store.

The energy store can be a battery, an accumulator such as, for example, a Li-ion or NiMH battery, or a supercap. The energy store may comprise a plurality of battery cells. The cells are disposed, for example, on an end plate or bottom, which is disposed opposite to the temperature-control device. The energy store can be suitable for operating a hybrid electric vehicle (HEV) or an electric vehicle (EV). The temperature-control device can have or be a temperature-control plate, which can function as a heat source or heat sink. The temperature-control device therefore can be used for heating or cooling the energy store. The temperature-control device in a preferred exemplary embodiment is made in the form of a temperature-control plate and can have one or more flow channels for the conducting or through-flow of a fluid such as, for example, a coolant. The transition apparatus therefore is a thermal transition apparatus. It is suitable for producing a planar connection between the temperature-control device and the energy store. The thermal transition apparatus can also be arranged between a surface of the temperature-control device and a surface of an additionally disposed heating device. Therefore, the transition apparatus can be placed below the temperature-control plate, e.g., if the heating device is located below the temperature-control plate.

The first incompressible layer can have a curable and/or cured material. Curable materials are preferably applied to surfaces, to be contacted, in a temporarily flowable, in particular liquid or viscous, phase, are cured by means of a chemical reaction, and then form an incompressible solid film on the contact surfaces. After a curing process, the material can be converted into a solid, first incompressible layer, which connects the temperature-control device and the energy store or the end plate or the bottom of the energy store by bonding or in a positive manner. The first layer is already incompressible, because it is applied as a temporarily flowable substance as a layer. The curing process produces a preferably three-dimensional crosslinking of the components of the material and a glass-like layer forms which is incompressible. In this case, the first incompressible layer can have a one-component material, a two-component material, or a multicomponent material. The materials can crosslink and thereby cure, for example, by an increase in temperature or by chemical activation. Preferably, the curable substances can connect two parts, for example, the temperature-control plate and the end plate of the energy store. The connection in this case can be preferably a bonded or positive connection. The connection can be separable or inseparable in this case.

The first incompressible layer can preferably have a thermosetting plastic or is formed completely of a thermosetting plastic. A thermosetting plastic is also called a thermoset and is a plastic that is no longer deformable after curing. Therefore, the thermosetting plastic can form the first incompressible layer. For example, an aminoplast or a phenoplast can be used as the thermosetting plastic. Further, epoxy resins, crosslinked polyacrylates, and/or polyurethanes can be used. The first incompressible layer of the transition apparatus preferably has a glass-like polymer material, which is rigidly crosslinked three-dimensionally by chemical primary valence bonds. Preferably, the first incompressible layer has a casting resin. The casting resin in this case can be a two-component casting resin, and in particular contain a two-component polyurethane as a material.

The first incompressible layer preferably has a thermal conductivity between 1 and 3.5 W/mK. The thermal conductivity of the first incompressible layer can influence the cooling, for example, of the energy store, in particular the necessary cooling performance. In the case of the same layer thickness, a high thermal conductivity is characterized by a low thermal resistance. The thermal conductivity in this case is inversely proportional to the thermal resistance. The lower the thermal resistance of the first layer, the lower the temperature gradient necessary for cooling.

In an exemplary embodiment, the transition apparatus has a second layer which serves as a thermal insulation layer. The second layer in this case preferably has a thermal insulating material which has a low thermal conductivity. The thermal resistance of the thermal insulation layer can be increased in certain regions by the low thermal conductivity of the insulating material by means of a selective distribution of the insulating material over the thermal insulation layer. The thermal insulation layer can have an insulating material distributed unevenly over a main extension direction of the second layer. “Unevenly distributed” in regard to the thermal insulation layer can mean that the material thickness of the insulating material and therefore of the entire thermal insulation layer varies over a main extension surface of the thermal insulation layer. The thermal insulation layer in this way can have different thicknesses. A material thickness of the insulating material can be substantially zero in one or more areas of the thermal insulation layer. In this case, the thermal insulation layer may comprise no insulating material in the area or areas. Thus, a thickness of the thermal insulation layer can also be zero in the area or areas. The thermal insulation layer can be formed of a rigid material or a material incompressible in regard to a contact pressure predominating between the energy store and the temperature-control device. The thermal insulation layer, however, can also be formed of an at least partially compressible material.

The second layer can have a material thickness between 50 μm and 300 μm, in particular of 150 μm. Insulation layers of this material thickness can be produced, for example, by screen printing.

The thermal conductivity of the second layer is preferably between 0.05 and 0.6 W/mK, in particular 0.2 W/mK. In this case, the material thickness of the insulation layer can be selected based on the thermal conductivity coefficient of the insulating material. The poorer the thermal conductivity, the thinner the insulation layer can be.

In an embodiment of the transition apparatus, the second layer can have a first area with a first average thermal resistance and a second area with a second average thermal resistance, whereby the first thermal resistance is not the same as the second thermal resistance. Therefore, the second layer has areas with a different thermal resistance, by means of which the heat arising in the energy store can be removed in a uniformly distributed manner. Preferably the second layer has a first area with a first material thickness and a second area with a second material thickness, whereby the first material thickness is not the same as the second material thickness. Therefore, the thermal resistance can be adjusted by means of different thicknesses of the second layer.

The transition from a first area to a second area can change continuously or occur in steps. A gradual transition or an abrupt transition can be provided in this way.

The thermal resistance of the insulation layer can increase or decrease along or transverse to a main extension direction of the temperature-control device. The thermal resistance and thereby the heating or cooling can be selectively controlled as a result.

The thermal resistance can be predetermined in sections by the area proportion of the thermal insulation layer relative to a temperature-control device surface section.

The temperature-control device can have an electrical heating layer, which is disposed adjacent to the first layer or to the second layer.

The temperature-control device can have at least one flow channel for the through-flow of a fluid.

The first incompressible layer and/or the second layer can be applied to the temperature-control device or to the temperature-control plate using a screen printing process. Screen printing is a usable process in which temporarily liquid materials can be applied to surfaces.

The temperature-control device can be a temperature-control plate.

The first incompressible layer and the second layer can be applied to a surface of the temperature-control device or the temperature-control plate.

The first layer can be applied to the surface of the temperature-control device and the second layer is applied to the first layer and/or that the second layer is applied to the surface of the temperature-control device and the first layer is applied to the second layer.

The object of the energy storage device is also achieved by an energy storage device with an energy store and a temperature-control device, whereby a transition apparatus of the invention is disposed between the energy store and the temperature-control device. The transition apparatus can have a first incompressible layer which serves as a tolerance compensation layer. Roughnesses with hills and valleys, which are caused by the technical surfaces of the temperature-control device and/or the cells of the energy store, can be smoothed in this way, so that a largest possible thermal contact surface is formed. The thermal contact surface is incompressible after the curing of the curable substances of the first layer and forms a positive connection between the temperature-control device and energy store. In this case, the inventor has determined that thermosetting plastics, as glass-like polymers, can produce a first incompressible layer with an optimal heat transfer.

The transition apparatus in this case can also form an arrangement of a plurality of functional layers, which makes it possible to influence selectively the thermal resistance between the temperature-control device and the surface of the energy store. In this way, a maximum temperature difference on a surface of the energy store, for example, a battery cell, can be kept as low as possible over time. As a result, for example, a battery cooling plate with a locally adapted thermal interface, also called LaThIn, can be realized.

As a result, it is no longer necessary to operate a temperature-control plate, for example, a cooling plate, with a suitably high coolant volumetric flow for the temperature control of an energy store, so that the temperature gradient in the coolant is kept low and the energy store or cells of the energy store can be cooled homogeneously. If the thermal resistance of the arrangement of a plurality of functional layers changes along a flow direction of the coolant, thus the coolant volumetric flow can be kept low, because a temperature gradient in the coolant can be compensated by the changing thermal resistance. By being able to avoid a high volumetric flow, low pressure losses occur in the system, so that the other components in the circuit can be dimensioned smaller. Thus, for example, small, light, and cost-effective pumps can be used in the coolant circuit of the temperature-control device.

In addition, a complex bracing device, which uniformly braces the energy store with the temperature-control device, can be omitted. As a result, inhomogeneities in the contact pressure, which influence the thermal resistance, can be compensated. The greater the contact pressure, the higher the thermal resistance and the better the energy store is cooled. If, therefore, the thermal resistance of the arrangement changes because of the inhomogeneities in the bracing, the differences in the thermal resistance can be compensated by introducing a plurality of functional layers. As a result, additional, complex elements for the bracing can also be omitted.

Advantageously, a homogeneous cooling or heating of an energy store can be realized by the transition apparatus with the functional layers. If the energy store has a plurality of cells, it can be assured that all cells are at about the same temperature level in each operational state.

The thermal insulation layer as the second layer can be disposed adjacent to the tolerance compensation layer as the first layer. The thermal insulation layer and the tolerance compensation layer can be arranged in the form of a stack and adjoin each other directly. Therefore, the tolerance compensation layer can also extend over areas of the thermal insulation layer that have a maximum material thickness of the insulating material. Tolerances of the thermal insulation layer can be well compensated by the tolerance compensation layer by the adjacent arrangement

The thermal insulation layer can have a first region with a first material thickness, a second region with a second material thickness, and a third region with a third material thickness. In this case, the second area can be disposed between the first and third area. The first material thickness can be greater than the second material thickness and the second material thickness can be greater than the third material thickness.

For example, the material thickness of the third area can also be thinner than the material thickness of the first area. The first area, second area, and third area can be disposed along a flow direction or a flow path length of a fluid within the temperature-control plate. The first area, second area, and third area can also be arranged parallel to a flow direction or a flow path length of the fluid within the temperature-control plate, if differences in the contact pressure are to be compensated. The first area in this regard can be arranged upstream with respect to the flow direction and the third area downstream with respect to the flow direction. The flow direction can apply, for example, to a cooling operation of the temperature-control plate. The material thickness can decrease continuously between a maximum material thickness in the first area and a minimal material thickness in the third area. In this regard, it is not necessary that the material thickness always decreases continuously or linearly. The decrease in the material thickness can also be exponential. Or, as described above, it can also be that, for example, the third area again has a greater thickness than the second area. In this way, different thermal resistances of the thermal transition apparatus can be realized by different thicknesses of the thermal insulation layer.

The thermal insulation layer can have a first section and a second section. In this regard, the insulating material can be disposed solely in the first section. No insulating material is therefore present in the second section. The thickness of the thermal insulation layer can be zero in the second section. In the first section, the thermal insulation layer can have the insulating material in a constant or a variable material thickness. The tolerance compensation layer can project into the second section. The tolerance compensation layer can have both a plurality of first sections and a plurality of second sections. The first section can be formed by a plurality of recesses in the second section or vice versa. The recesses can be, for example, round, oval, rectangular, triangular, hexagonal, or strip-shaped. The size or diameter of the plurality of the recesses can change along the flow direction. The first and second sections can be arranged alternately in the flow direction or transverse to the flow direction. An area proportion of the first section in regard to an area proportion of the second section in the thermal insulation layer can vary along the flow direction. The variation can also be parallel thereto, for example, if differences in the contact pressure are to be compensated. In this way, different thermal resistances of the thermal transition apparatus can be realized via the presence and absence of the insulating material within the thermal insulation layer.

The transition apparatus can have a heating layer. The heating layer can be placed adjacent to the tolerance compensation layer or adjacent to the thermal insulation layer. The transition apparatus thus can have a stack-like structure, which comprises at least the tolerance compensation layer, the insulation layer, and the heating layer.

The thermal transition apparatus can be heated by operation of the heating layer. The heating layer can be designed to convert electrical energy into heat. Depending on the embodiment of the heating layer, the heating layer can be designed in addition or alternatively to cool the transition apparatus. For example, the heating layer can comprise heating resistors or Peltier elements.

The object in regard to the method is achieved further with a method for producing an energy storage device, which an include the steps of arranging a temperature-control device, in particular a temperature-control plate, spaced apart from an end plate of an energy store; applying a first incompressible layer of a curable substance to the temperature-control plate or the end plate; and curing the first incompressible layer. Further, the method can have the step of arranging a second layer, which serves as a thermal insulation layer, before the curing.

The curing can occur here by application of heat, therefore at higher temperatures, in particular exothermically. The curing can also be activated chemically at room temperature, however, in particular isothermally. In this case, the process of crosslinking the curable material is activated by admixed catalysts. In addition, the curing can also be activated by radiation. During the curing process, preferably linear chain molecules can form, which can crosslink three-dimensionally with one another and thus can form a stable structure. After curing, this structure can no longer change and therefore the layer is permanently incompressible.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an energy storage device; and

FIG. 2 shows a further embodiment of an energy storage device.

### DETAILED DESCRIPTION

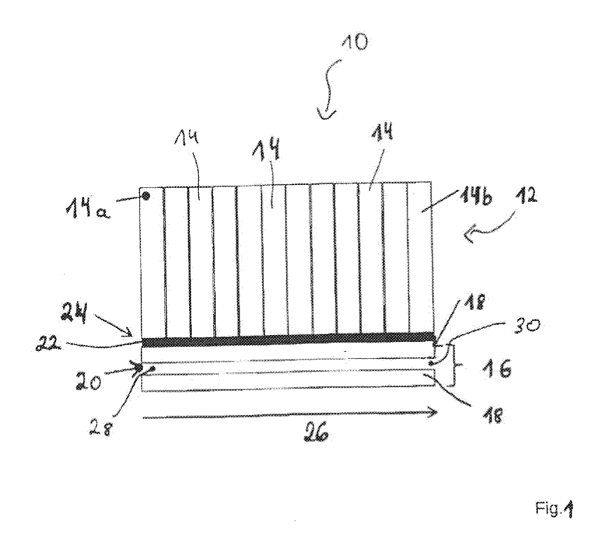

FIG. 1 in a schematic sectional illustration shows an energy storage device 10 according to an exemplary embodiment of the present invention. Energy storage device 10 has an energy store 12 with cells 14, for example, battery cells 14 or accumulator cells 14, and a temperature-control device 16, which has or forms at least one temperature-control plate. Temperature-control plate 18 is made in particular in the form of a cooling plate 18. Temperature-control plate 18 has at least one flow channel 20 and a thermal transition apparatus 22, arranged between cells 14 and temperature-control plate 18. Cells 14 in this case can be placed on an end plate (not shown here) or a bottom.

Cells 14 are arranged next to one another on a surface 24 of transition apparatus 22. During operation of energy storage device 10, a fluid can flow through flow channel 20 of temperature-control device or plate 18, in particular cooling plate 18. A flow path length or flow direction of the fluid between an inlet 28 and an outlet 30 of flow channel 20 is indicated by an arrow 26. The fluid has a temperature T_{Fluidin} at inlet 28. The fluid has a temperature T_{Fluidout} at outlet 30. A battery cell 14a located closest to inlet 28 has a temperature T_{cellin}. A battery cell 14b located closest to outlet 30 has a temperature T_{cellout}.

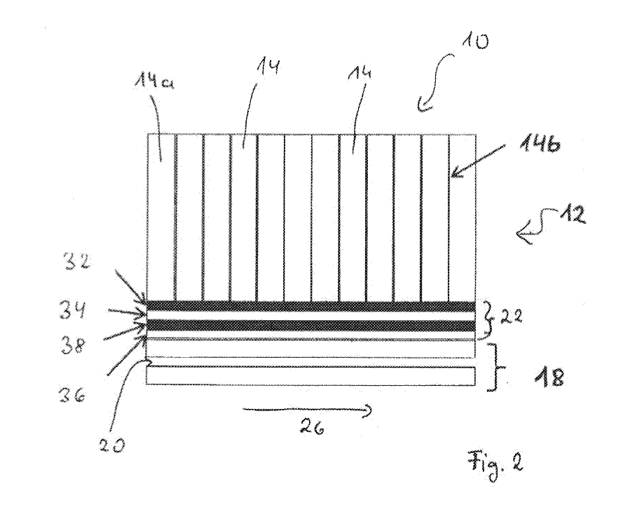

The structure of transition layer 22 is shown in greater detail in FIG. 2. FIG. 2 shows a schematic illustration of a further exemplary embodiment of energy storage device 10. Transition apparatus 22 has a first layer 32 and a second layer 34. First layer 32 is incompressible and formed as a tolerance compensation layer 32. Second layer 34 is formed as a thermal insulation layer 34. In addition, energy storage device 10 in the embodiment shown in FIG. 2 has a third layer 36 which is formed as electrical insulation layer 36. Energy storage device 10 also has a fourth layer 38 which is formed as heating layer 38.

First layer 32, second layer 34, third layer 36, and fourth layer 38 are called functional layers, because each of layers 32, 34, 36, and 38 have a specific function. Functional layers 32, 34, 36, and 38 are arranged stacked one above the other, whereby adjacently arranged layers 32, 34, 36, and 38 in each case touch one another. Electrical insulation layer 36 is arranged directly adjacent to temperature-control device 18, temperature-control plate 18, or cooling plate 18. Tolerance compensation layer 32 is arranged directly adjacent to cells 14. The layer structure of transition apparatus 22 as shown in FIG. 2 is a possible layer structure, which is not illustrated to scale. The sequence of layers 32, 34, 36, 38 can also be changed. Individual layers of layers 32, 34, 36, 38 can be omitted or replaced or supplemented by other suitable layers.

Transition apparatus 22, shown in FIGS. 1 and 2, has the functions stated below. First layer 32, which serves as tolerance compensation layer 32, has an incompressible material. The material of first incompressible layer 32 here has a coefficient of thermal conductivity in the range of approximately 1 W/mK to approximately 3.5 W/mK. The material of first incompressible layer 32 here is preferably a thermosetting plastic. The thermosetting plastic is produced, for example, by a temporarily liquid or fluid material, which is curable. The temporarily liquid material can be applied to cooling plate 18 and then cured. The curing in this case is activated by an increase in temperature or by a chemical activator. The activation here preferably involves a chemical reaction. Preferably, the material of the first layer is a casting resin, in particular a two-component casting resin, which after mixing of a first component and a second component, initiates a crosslinking and cures. The material of first layer 32 here is preferably formed on a polyurethane basis.

First incompressible layer 32 smooths out the unevenness with hills and valleys, which are present in the technical surfaces of cells 14 and/or cooling plate 18, and therefore has the effect of a tolerance compensation layer. The smoothing out here occurs in that the material of first incompressible layer 32, if it is in the temporarily liquid or at least viscous state, can enter the valleys. Therefore, a valley is filled in each case, and the unevenness of the surface is smoothed out, because the valleys filled with the material of first layer 32 and the hills can form a plane. As a result, the contact area between the surface of cooling plate 18 and the particular cell 14 is made larger. In particular after the curing, first layer 32 is unalterably incompressible and can no longer change its shape, in particular its thickness. The thickness of first layer 32 here is the expanse between temperature-control device 18 and the particular cell 14.

Second layer 34 serves as thermal insulation layer 34. Thermal insulation layer 34 equalizes an uneven temperature distribution, which can occur in individual cells 14. This occurs by suppressing the thermal heat transfer between the temperature-control device or cooling plate 18 and the particular cell 14. The thermal conductivity of second layer 34 here is between 0.05 and 0.6 W/mK, in particular 0.2 W/mK. The ideal thickness of second layer 34 here is between 50 μm and 300 μm, in particular 150 μm. In this case, the thickness of second layer 34 and the material-related heat transfer coefficient, which is also called thermal conductivity, are interacting parameters. A large layer thickness and a large thermal conductivity coefficient per unit length can lead to the same thermal resistance, like a lower layer thickness with a material with a somewhat lower thermal conductivity coefficient per unit length. It applies overall that the poorer the thermal conductivity of the material of thermal insulation layer 34, the thinner the layer thickness can be.

Second layer 34 is preferably not constructed as a layer with a homogeneous thermal resistance, but has areas with a different thermal resistance. For example, second layer 34 has a first area with a first thermal resistance and a second area with a second thermal resistance. The first and second thermal resistance are different in this case. The first area and the second area here are formed, for example, as continuously changing areas. For example, they have the form of areas with area proportions variable in flow direction 26, for example, with laterally increasing area proportions, for example, in the form of wedges, which have an increasing width when seen in flow direction 26 of the fluid. Alternatively, second layer 34 can also be made as strips or other geometric shapes of material with different widths or material thicknesses. In this case, the distance of the shapes along flow direction 26 can also change.

Examples of different embodiments for designing second layer 34 can be obtained from the publication DE 10211084002 A1 of the applicant, whose disclosure content is included herewith in its entirety in the disclosure content of the present patent application.

In particular, second layer 34, in particular thermal insulation layer 34, may have a first section and a second section each with a different thermal resistance, whereby the thermal resistance changes continuously from the first section and from the second section or changes discretely or in steps over at least one intermediate section. In this case, the thermal resistance of thermal insulation layer 34 increases or decreases along and/or transverse to flow direction 26, which is the main extension direction of energy storage device 10. As a result, the locally different temperatures of cooling plate 18 can be equalized. These different temperatures in cooling plate 18 can arise due to the fluid flow paths. The thermal resistance is preferably predetermined in sections by the area proportion of thermal insulation layer 34 relative to a section of the surface of temperature-control plate 18, in particular cooling plate 18.

The method for producing an energy storage device 10 comprises, apart from producing the individual components, such as cells 14 and temperature-control device 18, the application of first incompressible layer 32 to the surface of temperature-control device 18, said surface which faces cells 14. Further, preferably the application of second layer 34 to the surface of temperature-control device 18, said surface which faces cells 14, is provided. Alternatively, first layer 32 and/or second layer 34 can also be applied to an end plate of energy store 12, on which cells 14 are disposed. In this case, first layer 32 and/or second layer 34 are preferably applied using a screen printing method.

Energy storage device 10 preferably has battery cells or cells of an accumulator as cells 14 of energy store 12. Energy storage device 10 is preferably installed in a hybrid or electric motor vehicle.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A transition apparatus for an energy storage device comprising:
at least one energy store; and
at least one temperature-control device, the transition apparatus is adapted to bring a thermal transition between the temperature-control device and the energy store,
wherein the transition apparatus is arranged between the energy store and the temperature-control device, and
wherein the transition apparatus has at least one first incompressible layer that is a tolerance compensation layer.

2. The transition apparatus according to claim 1, wherein the first incompressible layer has a curable and/or a cured material.

3. The transition apparatus according to claim 1, wherein the first incompressible layer has a thermosetting plastic or is formed of thermosetting plastics.

4. The transition apparatus according to claim 1, wherein the first incompressible layer has a thermal conductivity between 1 and 3.5 W/mK.

5. The transition apparatus according to claim 1, wherein the transition apparatus has a second layer that is a thermal insulation layer.

6. The transition apparatus according to claim 5, wherein the second layer has a material thickness between 50 μm and 300 μm, in particular of 150 μm.

7. The transition apparatus according to claim 5, wherein the thermal conductivity of the second layer is between 0.05 and 0.6 W/mK, in particular 0.2 W/m K.

8. The transition apparatus according to claim 5, wherein the second layer has a first area with a first average thermal resistance and a second area with a second average thermal resistance, and wherein the first thermal resistance is not the same as the second thermal resistance.

9. The transition apparatus according to claim 5, wherein the second layer has a first area with a first material thickness and at least one second area with a second material thickness, and wherein the first material thickness is not the same as the second material thickness.

10. The transition apparatus according to claim 8, wherein the transition from a first area to a second area changes continuously or occurs in steps.

11. The transition apparatus according to claim 1, wherein the thermal resistance of the insulation layer increases or decreases along or transverse to a main extension direction of the temperature-control device.

12. The transition apparatus according to claim 1, wherein the thermal resistance is predetermined in sections by an area proportion of the thermal insulation layer relative to a temperature-control device surface section.

13. The transition apparatus according to claim 1, wherein the temperature-control device has an electrical heating layer, which is arranged adjacent to the first layer or to a second layer.

14. The transition apparatus according to claim 1, wherein the temperature-control device has at least one flow channel for the through-flow of a fluid.

15. The transition apparatus according to claim 1, wherein the first incompressible layer and/or a second layer are applied using a screen printing process to the temperature-control device.

16. The transition apparatus according to claim 1, wherein the temperature-control device is a temperature-control plate.

17. The transition apparatus according to claim 1, wherein the first incompressible layer and a second layer are applied to a surface of the temperature-control device or the temperature-control plate.

18. The transition apparatus according to claim 17, wherein the first layer is applied to the surface of the temperature-control device and the second layer is applied to the first layer and/or wherein the second layer is applied to the surface of the temperature-control device and the first layer is applied to the second layer.

19. An energy storage device with an energy store and a temperature-control device, wherein a transition apparatus according to claim 1 is arranged between the energy store and the temperature-control device.

20. The energy storage device according to claim 19, wherein the transition apparatus is arranged between a bottom of the energy store and the temperature-control device.

21. The energy storage device according to claim 19, wherein the temperature-control device is a temperature-control plate, which controls a temperature of the energy storage device.

22. The energy storage device according to claim 19, wherein the energy store is an accumulator or a battery.

23. A method for producing an energy storage device according to claim 19 comprising:
arranging a temperature-control plate spaced apart from an end plate of the energy store;
applying the first incompressible layer of a curable substance to the temperature-control plate or the end plate; and
curing the curable substance of the first incompressible layer.
